(19) United States
(12) Patent Application Publication
(10) Pub. No.: US 2024/0066328 A1
(43) Pub. Date: Feb. 29, 2024

(54) Device for Storing a Rope for a Descender and Assembly Comprising a Descender and the Device

(71) Applicant: SKYLOTEC GmbH, Neuwied (DE)

(72) Inventor: Philipp Leo VITT, Koblenz (DE)

(21) Appl. No.: 18/452,967

(22) Filed: Aug. 21, 2023

(30) Foreign Application Priority Data
Aug. 31, 2022 (EP) 22193302.1

(51) Int. Cl. A62B 1/18; A62B 1/14; A62B 1/16; A62B 35/00

(52) U.S. Cl. CPC A62B 1/18; A62B 1/14; A62B 1/16; A62B 35/0075

(57) ABSTRACT

A device for storing a rope for a descender includes the rope, a rope drum, and a dimensionally stable rope bag, wherein the rope has a diameter of less than or equal to 8 mm and is at least partially wound on the rope drum in such a way that a first end of the rope can be unwound from the rope drum, and wherein the rope drum is disposed in the rope bag in such a way that the first end of the rope can be led out of an opening) of the rope bag. Furthermore, an assembly includes a descender and the above-mentioned device, wherein the descender includes a centrifugal brake configured such that a rope passing through the descender can be slowed down in its motion, and wherein the rope of the device is passed through the descender.

### TECHNICAL FIELD

The invention relates to a device for storing a rope for a descender. Furthermore, the invention relates to an assembly comprising the abovementioned device and a descender. Moreover, the invention relates to the use of the abovementioned assembly.

### BACKGROUND OF THE INVENTION

In order to carry out work in places which are difficult to access, for example at great heights, rope access techniques may be used in which a worker, also known as a rope access technician, abseils down to the work site. Rope access technicians are usually used when it is either too expensive or too inconvenient to erect a crane or scaffold to gain access to the work site. For example, rope access technicians clean windows on high-rise buildings or carry out assembly, maintenance and repair work on wind turbines.

In order to descend as reliably as possible from the elevated work site to the ground in emergency situations, descenders, also known as abseiling devices, can be kept on hand at the work site. A descender is a device by use of which a user can safely descend from an elevated position to a lower position under a nominal load on a rope of the descender by slowing down the rope as it moves through the descender.

For example, EP 2 512 605 B1 describes a descender comprising a housing through which a rope is passed over a distance, wherein almost no force is exerted on the rope in a load-free position. The descender comprises a through hole in which a load to be descended can be fixed, wherein one of the ends of the rope is fixed at the starting point of the abseiling operation and the load is moved downwards along the rope together with the descender.

Descenders, however, are not only relevant for planned work operations of rope access technicians, but are also used in the field of (occupational) protection and rescue. For example, if a firefighter or operator of a work platform becomes trapped by a fire, he or she must be able to rescue him- or herself quickly. Appropriate descenders must always be carried along in special work situations. It should also be noted that the length of the rope of the descender carried along determines the maximum height from which safe abseiling is still possible. Especially for operations at very high altitudes, for example 150 m and more, the descenders are correspondingly large, heavy and unwieldy. Since the descenders are carried along by the user at his body, there is a need to provide descenders that are as small and lightweight as possible.

### DESCRIPTION OF THE INVENTION

Based on this situation, it is an object of the present invention to provide means to reduce the weight of descenders and/or to enable longer abseiling distances.

The object is achieved by the features of the independent claims. Advantageous embodiments are provided in the subclaims.

Accordingly, the object is achieved by a device for storing a rope for a descender, wherein the device comprises the rope, a rope drum and a dimensionally stable rope bag, the rope has a diameter of less than or equal to 8 mm and is at least partially wound on the rope drum such that a first end of the rope is unwindable from the rope drum, and the rope drum is arranged in the rope bag such that the first end of the rope can be led out of an opening of the rope bag.

Further, the object is achieved by an assembly comprising the above device and a descender, wherein the descender comprises a centrifugal brake configured such that a rope passing through the descender can be slowed down while moving, and the rope of the device is passed through the descender.

According to one aspect of the invention, the rope has a diameter of less than or equal to 8 mm, and is at least partially wound on the rope drum disposed in the rope bag. Preferably, at least ¾ of the rope is wound on the rope drum, and more preferably substantially all of the rope is wound on the rope drum. Devices and/or assemblies known in the prior art comprising the device and the descender for long abseiling distances are large, heavy and unwieldy due to the long rope required for this purpose, so that they cannot be carried along by the user on the body or only with great effort. Unexpectedly, it has been shown that reducing the diameter of the rope, however, causes the rope stored in the rope bag to become tangled and/or knotted during abseiling, which makes abseiling impossible or highly unsafe. The at least partial winding of the rope around the rope drum and the arrangement of the rope drum in the dimensionally stable rope bag reduce the risk of knots forming in the rope or of the rope becoming entangled when the rope is pulled out of the rope bag as a result of the abseiling and thus enable safe abseiling even for long abseiling distances.

The rope is wound on the rope drum in such a way that the first end of the rope can be unwound from the rope drum. In other words, the rope can be unwound from the drum by pulling at the first end. Since during abseiling the first end of the rope is preferably used for attachment to an anchor point, the rope carried along in the rope bag is thus unwound from the rope drum during abseiling.

The rope drum is preferably mounted without connection in the dimensionally stable rope bag, which means that the rope drum is not mechanically connected to the rope bag, for example by a screw connection, but can be moved relative to the rope bag with a certain amount of play. Preferably, the play for movement of the rope drum in the rope bag is limited by the inner dimensions of the rope bag. The storing of the rope drum in this manner and the winding of the rope onto the rope drum preferably ensure that the rope runs undisturbed during abseiling, so that the safety of the user is ensured despite the small diameter of the rope. In addition, the small diameter of the rope makes it possible to provide a very lightweight and small device for storing the rope and/or a very lightweight and small arrangement comprising the device and the descender, in particular also for long abseiling distances.

A dimensionally stable rope bag means in the present context that the rope bag substantially retains its shape even in the unfilled state and does not collapse due to the own weight of the rope bag. However, this does not mean that the rope bag is completely inflexible—i.e. rigid in shape. Preferably, the rope bag is not designed as a plastic bag, bag made of a plastic film and/or polybag, and preferably does not have completely slack and completely deformable properties. Preferably, it may moreover be provided that the rope bag is designed as a rope bag that can be sleeved over the rope drum and/or pulled off the rope drum.

The diameter of the rope is 8 mm or less than 8 mm, and preferably less than 8 mm. Further preferably, the rope has a diameter of less than or equal to 6.5 mm, and particularly preferably less than or equal to 6 mm. In a preferred example, the diameter of the rope is 5.9 mm±0.3 mm or 5.5 mm±0.3 mm. Further preferably, the rope has a diameter of less than or equal to 4.5 mm and particularly preferably less than or equal to 4 mm. These rope diameters have been found to be particularly suitable, on the one hand, in order to meet the mechanical requirements and/or stresses of abseiling and, on the other hand, to provide a lightweight device and/or a lightweight assembly comprising the device and the descender. For example, the device allows an assembly with 200 m of rope to weigh less than 6 kg.

According to a preferred further development of the invention, it is preferably provided that the rope drum comprises a cylindrical rope pulley, an axle pushed through the rope pulley and two circular support discs. It is further preferably provided that the rope pulley is rotatably mounted about the axle, the axle is connected at both ends to a respective support disc, and the diameter of the support discs is larger than the diameter of the rope pulley completely wound up with the rope. These features advantageously allow that when the rope is unwound from the drum, preferably the cylindrical rope pulley rotates around the axle, wherein friction of the rope pulley at the rope bag is avoided in that the diameter of the support discs is larger than the diameter of the rope pulley completely wound up with the rope. In other words, preferably the weight of the rope drum rests on the support discs and/or the rope pulley is rotatably mounted in a freely suspended manner.

Alternatively or additionally, according to another preferred further development of the invention, it is provided that the rope bag comprises at least two pulleys in such a way that two outer portions of the rope drum are mounted on the pulleys, and/or that the rope drum is supported between side walls of the rope bag. Preferably, therefore, the axle of the rope drum can be dispensed with and a rotatable mounting of the rope drum can be achieved by the rope bag comprising pulleys. Furthermore, the rope drum can be rotatably mounted between the side walls of the rope bag.

According to another preferred further development of the invention, it is provided that the device comprises a storage bag, wherein the rope drum is arranged in the storage bag. Since the device for storing the rope for the descender and/or the assembly comprising the device and the descender is preferably an emergency device which is ideally only rarely used, a storage which does not negatively affect the usability of the device and/or the assembly is of great advantage. Particularly preferably, the storage bag prevents UV rays and/or moisture from negatively affecting the rope and/or prevents corrosion. Further preferably, the storage bag is made of aluminum and enables a gas-tight sealing of the rope drum stored in the storage bag. In addition, an anticorrosion agent, a drying agent and/or a protective gas can be arranged in the storage bag in order to extend the storage life.

According to another preferred further development, it is provided that the device comprises a padding, wherein the padding is arranged between the rope drum and a side wall of the rope bag. Preferably, the padding is configured such that the padding protects the rope drum from downfall damages and thus protects the functionality of the rope pulley. Preferably, the padding is designed as foam sheets, which further preferably are circular and/or have a thickness of 2 mm.

In this context, according to another preferred further development, it is provided that the device comprises the storage bag and the padding, wherein the rope drum is arranged in the storage bag and the padding is arranged between the rope drum and a side wall of the storage bag and in particular between the support disc of the rope drum and the side wall of the storage bag. The padding preferably arranged between the rope drum and the side wall of the storage bag also prevents in a simple manner the storage bag from being damaged when the device is carried along and/or when the assembly is carried along at the body of the user. According to another further development of the invention, it may be provided that the support discs of the rope drum comprise a padding integrated into the support discs and/or the padding is applied directly onto the support discs and/or is connected to the support disc.

According to yet another preferred further development of the invention, it is provided that the rope bag has a shape corresponding to the rope drum, preferably the shape of a body of rotation, comprises a closable opening at a circumferential surface, and/or that the rope bag comprises fastening means for fastening the rope bag to a user. Preferably, the fastening means are in the form of eyelets, hooks, clips, carriers and/or buckles and preferably allow the rope bag to be easily connected to the body of the user. The shape of the rope bag preferably corresponds to the shape of the body of rotation, wherein the axis of rotation of the body of rotation preferably extends parallel to the axis of rotation of the rotatably mounted rope drum. Accordingly, the device is very compact and the range of movement of the rope drum in the rope bag is sufficiently limited by the internal dimensions of the rope bag. Preferably, the rope bag has a cylindrical shape or has the shape of an ellipsoid. The cylindrical or ellipsoidal shape of the rope bag corresponds to the substantially cylindrical shape of the rope drum, so that the device is very compact. Further preferably, the closable opening is closable with a zipper and/or Velcro. In addition, the arrangement of the opening in the circumferential surface ensures that the rope can be unwound from the rope drum particularly well during abseiling.

Despite the small rope diameter, the rope preferably has the high load-bearing capacity required for the abseiling process. With respect to the rope, according to another preferred further development of the invention, it is provided that the rope is a hybrid rope and/or that the rope comprises a core and a sheath bonded to the core. A hybrid rope is preferably a rope made of at least two different materials. It has been shown that a hybrid rope has the advantage of providing the mechanical load-bearing capacity required for abseiling even with a small diameter. Particularly preferably, the hybrid rope comprises two mutually different synthetic polymer fibers. Synthetic polymer fibers have the advantage of having a low own weight, so that a particularly lightweight device for storing the rope and/or a particularly lightweight assembly comprising the device and the descender can be provided. The bonding of core and sheath of the rope also enables a high mechanical load-bearing capacity and, at the same time, an advantageous braking behavior during abseiling. Further preferably, the rope has a high heat resistance, particularly preferably up to 450° C. Thus, the device for storing the rope and/or the assembly comprising the device and the descender can also be used for self-rescue in fire situations.

In this context, moreover, according to another preferred further development of the invention, it is provided that core and sheath are thermally bonded with at least one adhesive thread laid spirally on the core. Preferably, core and sheath can also be bonded to each other with more than one adhesive thread, particularly preferably with two adhesive threads. It has been found that a rope manufactured in this way is particularly suitable for the abseiling process and/or the descender, since it combines particularly well a small diameter of the rope with a high mechanical load-bearing capacity and with a high abrasion resistance.

According to another preferred further development of the invention, the core of the rope comprises aramid and/or the sheath of the rope comprises polyamide, preferably polyamide 6. Aram id is a polyamide in which the amide groups are bonded to aromatic groups. Aramids have the advantage of being very tensile resistant and tough, as well as having a high chemical resistance. Particularly preferably, the core comprises a polyamide prepared from the monomers terephthalic acid dichloride, p-phenylenediamine, and/or 3,4′-diaminodiphenyl ether. Polyamides are linear polymers with regularly repeating amide bonds along the backbone. Polyamide 6, which is also called polycaprolactam, exhibits high toughness and wear resistance.

Further technical effects and advantages of the device for storing the rope for the descender will be apparent to those skilled in the art from the description of the assembly comprising the device and the descender, the use of the assembly, and from the description relating to the exemplary embodiments and the figures.

As already mentioned, the invention also relates to an assembly comprising the device and the descender. The object is thus achieved by the assembly comprising the device and the descender, wherein the device comprises the rope, the rope drum and the dimensionally stable rope bag, wherein the rope has a diameter of less than or equal to 8 mm and is at least partially wound on the rope drum, such that the first end of the rope can be unwound from the rope drum, wherein the rope drum is arranged in the rope bag in such a way that the first end of the rope can be led out of an opening of the rope bag, wherein the descender comprises the centrifugal brake designed in such a way that a rope moving through the descender can be slowed down in its motion, and wherein the rope is passed through the descender.

According to a preferred further development of the invention, the assembly comprises a fastening device, wherein the rope is connected with the first end to the fastening device. Preferably, the fastening device is adapted to be attached for abseiling to an anchor point from where the user can abseil downwardly at the rope by means of the descender. Preferably, the fastening device is designed as a snap hook.

The descender and preferably the centrifugal brake of the descender preferably allow the load on the descender to be descended at a controlled speed. In this respect, according to another preferred further development of the invention, it is provided that the descender comprises a through hole for fastening the descender. In this way, the descender can be easily attached to the body of the user so that the user can safely abseil at the rope. Preferably, the user carries the device for storing the rope along, which is also attached to the user's body and from which the rope unwinds during abseiling.

With regard to the descender, according to another preferred further development of the invention, it is provided that the descender is free of a transmission and/or that the descender unwinds unattended and/or automatically. The absence of a transmission makes the descender particularly easy to operate and also robust, since possible defects relating to the transmission cannot occur. In addition, the descender is preferably designed in such a way that hands-free abseiling is possible, which means that no handle or the like on the descender has to be operated by the user during the abseiling process. Thus, a user can abseil by means of the descender even if, for example, one of the user's hands is no longer usable due to an injury, or if the user even loses consciousness during the abseiling process. In contrast to manual descenders, where a handle, lever or the like must be operated during the abseiling process, the present descender therefore preferably allows abseiling without interfering with the abseiling process.

According to another preferred further development of the invention, it is provided that the descender comprises a load-dependent braking mechanism and/or is designed to slow down the motion of the rope by means of sliding friction. With respect to the load-dependent braking mechanism, it is particularly preferably provided that in a load-free position almost no force is exerted on the rope. In other words, the descender thus has a positioning function that allows the user to position himself prior to the abseiling process without increased force. Preferably, the descender can tilt via an axle at which the descender is suspended, wherein the suspension is preferably implemented via the through hole, for example by means of a snap hook at the user. Due to the tilting, the higher the load at the descender and thus at the exiting rope, the more the entering rope is slowed down.

With regard to the tilting of the descender, it is preferably provided that a slider of the descender transfers the force of the user's weight to another side of the descender during tilting. As a result, the rope is not slowed down behind the descender, but in front of the descender. As a result, the rope is subjected to particular tension inside the device, since at the rope entry side of the descender friction of the rope via the slider occurs and at the rope exit side of the descender tension on the rope via the user's weight occurs. Due to the increased tension of the rope an effective wrapping of a rope pulley of the descender is possible, whereby a large force can be transmitted by means of a very small rope pulley. The described function of the descender thus makes the descender particularly small and lightweight, since only a small rope pulley is necessary.

The descender, and preferably the centrifugal brake, is also particularly preferably designed in such a way that it maintains its function even with wet rope and enables safe abseiling. According to another further development, the descender is also preferably designed for a user weight of 60 kg to 140 kg. In particular, in this weight range, the descender can be used without the user having to set a weight indication on the descender. Thus, the descender and correspondingly the assembly comprising the descender and the device for storing the rope is particularly user-friendly and exhibits a high degree of operating safety, since in an emergency situation the user need only attach the first end of the rope preferably by means of the fastening device to an anchor point and can abseil immediately.

According to another preferred further development of the invention, it is provided that the assembly comprises a lanyard wearable at the body. In particular, when the assembly and/or the abseiling device is designed as a self-rescue device, as well as a self-rescue device for non-professional users, it is advantageous if the lanyard wearable at the body is directly part of the assembly. In this context, according to another preferred further development, it is provided that the lanyard wearable at the body is designed as a rescue triangle, climbing harness, seat harness, chest harness, fall arrest harness and/or tether. With a rescue triangle in particular, even inexperienced users can abseil safely.

In accordance with a further development of the invention, it is particularly preferred that the lanyard wearable at the body can be connected to the through hole of the descender. In this way, the user's body is connected to the descender and to the rope passing through the descender during abseiling.

Further technical effects and advantages of the assembly comprising the device for storing the rope and the descender are obvious for those skilled in the art from the description of the device, the use of the assembly as well as from the description of the exemplary embodiments and the figures.

Furthermore, the invention relates to the use of the assembly described above for a) abseiling from a wind turbine, from a building, from a lifting platform, from a crane, and/or from a high-bay warehouse and/or b) for abseiling for abseiling distances of at least 3 m, preferably for abseiling distances of at least 20 m, more preferably for abseiling distances of at least 50 m, more preferably for abseiling distances of at least 100 m, more preferably for abseiling distances of at least 150 m, and particularly preferably for abseiling distances of at least 200 m or for abseiling distances of 200 m. Preferably, the wind turbine, the building, the lifting platform, the crane, and/or the high-bay warehouse is at least 3 m, preferably at least 20 m, more preferably at least 50 m, more preferably at least 100 m, and particularly preferably at least 150 m high. Further preferably, the wind turbine, the building, the lifting platform, the crane, and/or the high-bay warehouse is 200 m high or more. In particular in the case of very long abseiling distances, preferably longer than 150 m, further preferably in case of abseiling distances of 200 m length or more, the above described assembly comprising the device for storing the rope and the descender has the advantage that it can always be carried along by the user due to its light weight.

Further technical effects and advantages of the use of the assembly are obvious for those skilled in the art from the description of the device for storing the rope for the descender, the assembly comprising the device and the descender, as well as from the following description of the exemplary embodiments and the figures.

### BRIEF DESCRIPTION OF THE DRAWINGS

In the following, the invention is explained in more detail with reference to the accompanying drawings based on preferred exemplary embodiments.

In the Figures:

FIG. 1 shows a rope pulley of a device for storing a rope according to a first preferred exemplary embodiment of the invention;

FIG. 2 shows the rope pulley of FIG. 1, which is connected to support discs,

FIG. 3 shows the rope pulley of FIG. 1, which is arranged in a storage bag;

FIG. 4 shows a rope bag of a device for storing a rope according to another preferred exemplary embodiment of the invention,

FIG. 5 shows a cross-sectional view and a side view of a support disc of the device of FIG. 4; and

FIG. 6 shows a plurality of views of a descender of an assembly comprising the descender and the device for storing the rope according to a further preferred exemplary embodiment of the invention.

### DETAILED DESCRIPTION OF THE EXEMPLARY EMBODIMENTS

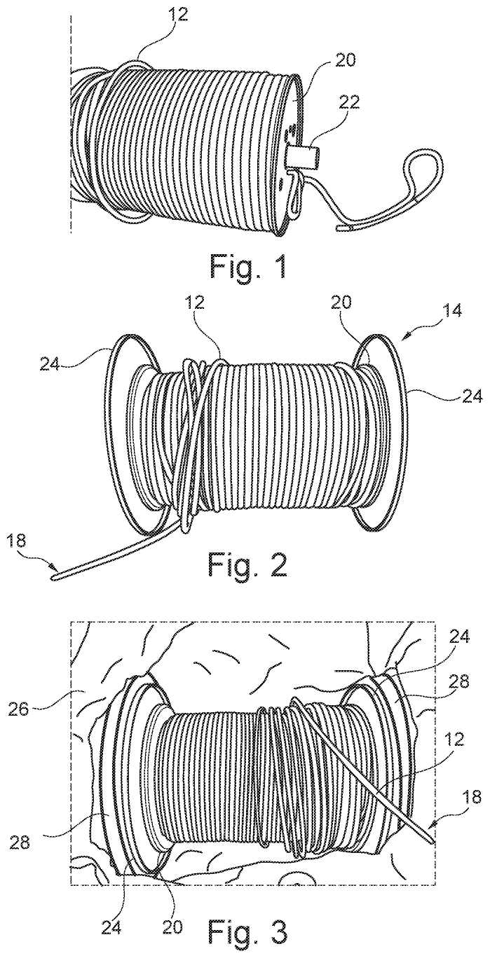

FIGS. 1 to 3 schematically show different components of a device 10 for storing a rope 12 for a descender 44 according to a first preferred exemplary embodiment of the invention. In the present exemplary embodiment, the device 10 comprises a rope 12, a rope drum 14 (see FIG. 2) and a dimensionally stable rope bag 16 (not shown in FIGS. 1 to 3). As can be seen from FIGS. 1 to 3, the rope 12 is at least partially wound on the rope drum 14, so that a first end 18 of the rope 12 can be unwound from the rope drum 14. In the present exemplary embodiment, the rope 12 has a diameter of 5.9 mm.

In addition, the rope drum 14 shown in FIG. 2 comprises a cylindrical rope pulley 20 shown in FIG. 1, an axle 22 pushed through the rope pulley 20 and two circular support discs 24, wherein the support discs 24 are only shown in FIG. 2 and not in FIG. 1. The rope pulley 20 is rotatably mounted around the axle 22, wherein the axle 22 is connected at both ends to a respective support disc 24. In addition—as can be seen in particular in FIG. 2—the diameter of the support discs 24 is larger than the diameter of the rope pulley 20 completely wound up with the rope 12.

In the exemplary embodiment shown in FIGS. 1 to 3, it is not only provided that the rope drum 14 is arranged in the rope bag 16 (not shown) in such a way that the first end 18 of the rope 12 can be led out of an opening of the rope bag 16, but also that the device 10 comprises a storage bag 26 (see FIG. 3). In the present exemplary embodiment, the storage bag 26 is made of aluminum and is closable in a gas-tight manner. In addition, the device 10 in the present exemplary embodiment comprises a padding 28, which is arranged between the support disc 24 and a side wall of the storage bag 26. In the present embodiment, the padding 28 comprises two circular foam sheaves.

The rope 12 of the device shown in FIGS. 1 to 3 is a hybrid rope having a core of aramid and a sheath of polyamide 6. The core is thermally bonded to the sheath by two adhesive threads laid spirally on the core.

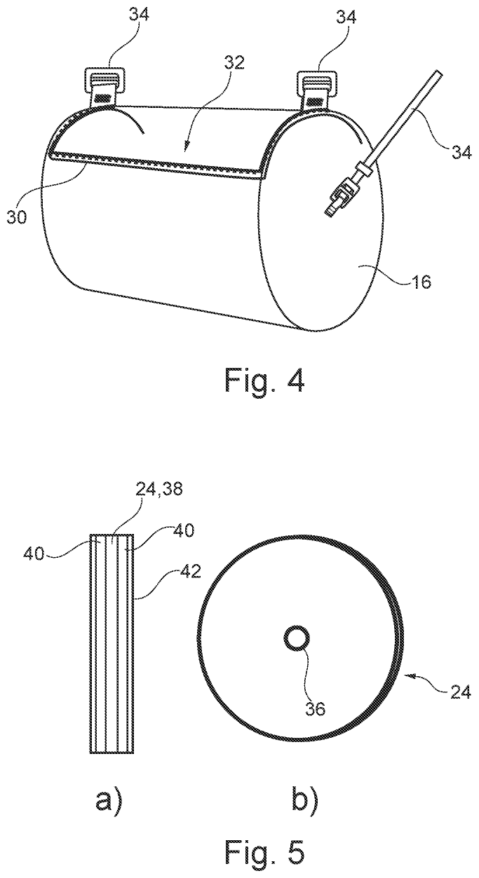

FIG. 4 schematically shows a rope bag 16 of a further preferred exemplary embodiment of the device 10. In this exemplary embodiment, the dimensionally stable rope bag 16 has a cylindrical shape and an opening 32 on a circumferential surface which can be closed with a zipper 30. The diameter of the rope bag 16 is 29 cm and the length 35 cm. In addition, the rope bag 16 comprises fastening means 34 for fastening the rope bag 16 to a body of the user.

FIG. 5 schematically shows a circular support disc 24 of the rope drum 14 of the device 10 arranged in the rope bag 16 of FIG. 5. The support disc 24 has a diameter of 23 cm. In addition, the support disc 24 has an opening 36 in the center for connecting the support disc 24 to the axle 22 (not shown in FIG. 5) of the rope drum 14. As can be seen from the cross-sectional view of the support disc 24 in FIG. 5a), the support disc 24, which is designed as a plastic sheave 38, is covered on both sides by a foam layer 40 as padding 28, wherein all three layers are covered by a textile layer 42.

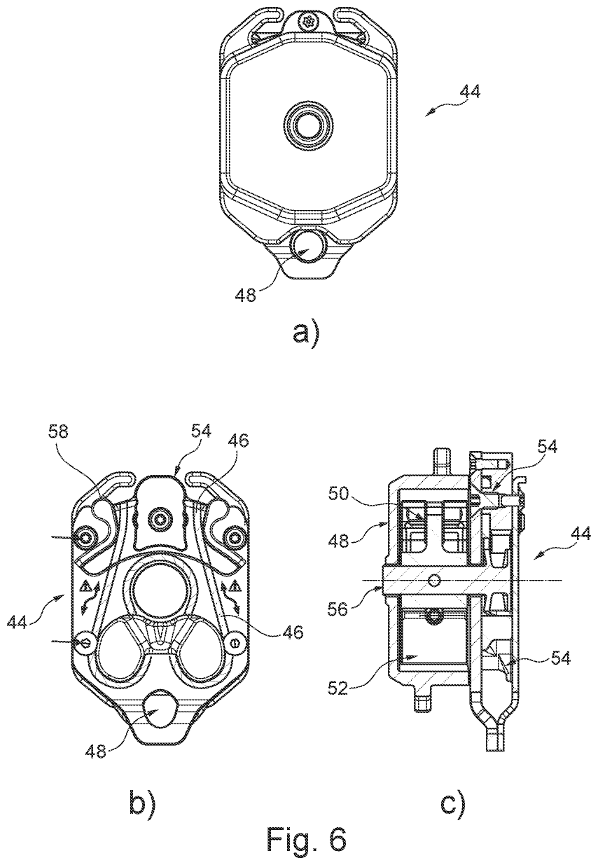

FIG. 6 schematically shows several views of a descender 44 of an assembly comprising the device 10 for storing the rope 12 and the descender 44, according to a further preferred exemplary embodiment of the invention. FIG. 6 shows only the descender 44 and not the entire assembly. The descender 44 comprises a centrifugal brake designed in such a way that a rope 12 (the rope itself is not shown) passing through the descender 44 can be slowed down during its motion. Accordingly, the assembly is such that the rope 12 is passed through the descender 44, wherein the rope path 46 having a plurality of deflections is shown in FIG. 6b).

Furthermore, as can be readily seen in FIGS. 6a) and 6b), the descender 44 comprises a through hole 48 for attaching the descender 44 to a body of the user. The descender 44 is free of a transmission. Instead, the descender 44 includes a brake drum 48, a brake core 50, a centrifugal weight 52, multiple deflections 54, and a rope sheave/axle 56. In addition, the descender 44 is configured to unwind unattended and automatically without requiring the user to operate any handle or lever of the descender 44. Furthermore, the braking mechanism is configured to be load dependent by means of the slider 58 so that in a load-free position, virtually no force is applied to the rope 12.

The described exemplary embodiments are merely examples, which may be modified and/or supplemented in a variety of ways within the scope of the claims. Any feature that has been described for a particular exemplary embodiment may be used independently or in combination with other features in any other exemplary embodiment. Any feature that has been described for an exemplary embodiment of a particular category can also be used in a corresponding manner in an exemplary embodiment of another category.

### LIST OF REFERENCE SYMBOLS

10 device
12 rope
14 rope drum
16 rope bag
18 first end of the rope
20 rope pulley
22 axle
24 support disc
26 storage bag
28 padding
30 zipper
32 closable opening
34 fastening means
36 opening
38 plastic sheave
40 foam layer
42 textile layer
44 descender
46 rope path
48 brake drum
50 brake core
53 centrifugal weight
54 deflection
56 rope sheave/axle
58 slider

1-15. (canceled)

16. Device for storing a rope for a descender, wherein the device comprises the rope, a rope drum and a dimensionally stable rope bag, wherein:
the rope has a diameter of less than or equal to 8 mm and is at least partially wound onto the rope drum such that a first end of the rope can be unwound from the rope drum, and
the rope drum is disposed in the rope bag in such a way that the first end of the rope can be led out of an opening of the rope bag.

17. Device according to claim 16, wherein the rope drum comprises a cylindrical rope pulley, an axle pushed through the rope pulley and two circular support discs, wherein the rope pulley is rotatably mounted about the axle, the axle is connected at both ends to a respective support disc, and the diameter of the support discs is larger than the diameter of the rope pulley completely wound up with the rope.

18. Device according to claim 16, wherein the rope bag comprises at least two rollers such that two outer portions of the rope drum are mounted on the rollers.

19. Device according to claim 16, wherein the rope drum is mounted between side walls of the rope bag.

20. Device according to claim 16, comprising a storage bag, wherein the rope drum is disposed in the storage bag and/or comprising a padding, wherein the padding is disposed between the rope drum and at least one of a side wall of the rope bag and the storage bag.

21. Device according to claim 16, wherein the rope bag has a shape corresponding to the rope drum, comprises a closable opening on a circumferential surface.

22. Device according to claim 16, wherein the rope bag comprises fastening means for fastening the rope bag to a user.

23. Device according to claim 16, wherein the rope is a hybrid rope.

24. Device according to claim 16, wherein the rope comprises a core and a sheath bonded to the core.

25. Device according to claim 24, wherein core and sheath are thermally bonded with at least one adhesive thread laid spirally on the core.

26. Device according to claim 24, wherein the core of the rope comprises aramid and/or wherein the sheath of the rope comprises one of polyamide or polyamide 6.

27. Assembly comprising a descender and a device according claim 16, wherein the descender comprises a centrifugal brake designed in such a way that a rope passing through the descender can be slowed down in its motion, and wherein the rope of the device is passed through the descender.

28. Assembly according to claim 27, comprising a fastening device preferably designed as a snap hook, wherein the rope is connected at the first end to the fastening device.

29. Assembly according to claim 27, wherein the descender comprises a through hole for fastening the descender, wherein the descender is free of a transmission and/or wherein the descender unwinds at least one of unattended and automatically.

30. Assembly according to claim 27, wherein the descender comprises a load-dependent braking mechanism.

31. Assembly according to claim 27, wherein the descender is configured to slow down the motion of the rope by means of sliding friction.

32. Assembly according to claim 27, wherein the assembly comprises a lanyard wearable at the body.

33. Assembly according to claim 27, wherein the lanyard wearable at the body is configured as at least one of a rescue triangle, a climbing harness, a seat harness, a chest harness, a fall arrest harness and a tether.

34. Assembly according claim 31, wherein the lanyard wearable at the body is connectable to the through hole of the descender.

35. Use of the assembly according to claim 27 for at least one of:
a) abseiling from at least one of a wind turbine, from a building, from a lifting platform, from a crane, and from a high-bay warehouse, and
b) abseiling for abseiling distances of at least one of 3 m, 50 m, 100 m and 150 m.
